(19) United States
(12) Patent Application Publication
(10) Pub. No.: US 2009/0083465 A1
(43) Pub. Date: Mar. 26, 2009

(54) Method for Automatic Configuration of a Process Control System and Corresponding Process Control System

(76) Inventors: Ralf Schaetzle, Fischerbach (DE); Fridolin Faist, Wolfach (DE)

Correspondence Address: FAY KAPLUN & MARCIN, LLP, 150 BROADWAY, SUITE 702, NEW YORK, NY, 10038, US

(21) Appl. No.: 12/323,973

(22) Filed: Nov. 26, 2008

Related U.S. Application Data
(63) Continuation of application No. 11/117,011, filed on Apr. 28, 2005.
(60) Provisional application No. 60/568,203, filed on May 5, 2004.

(51) Int. Cl. G06F 13/40; G06F 9/06

(52) U.S. Cl. 710/110; 712/220; 712/E09.003

(57) ABSTRACT

A process control system and a method for automatic configuration of the system are described. The system includes a master and at least one slave, whereby the master controls the at least one slave, which is connected to and communicates with the master via a bus system, and processes data received from the at least one slave. The master automatically identifies the at least one slave via the bus system, and subsequently automatically generates a slave configuration for setting up the slave according to its identification such that the slave is ready to be operated in the process control system.

### PRIORITY CLAIM

This application claims the benefit of and is a continuation of U.S. patent application Ser. No. 11/117,011 filed on Apr. 28, 2005 entitled “Method for Automatic Configuration of a Process Control System and Corresponding Process Control System” which claims priority to U.S. Provisional Patent Application Ser. No. 60/568,203 filed on May 5, 2004, specifications of both applications are expressly incorporated herein, in their entirety, by reference

### TECHNICAL FIELD OF THE INVENTION

The present invention relates to the field of measurement and control technology. In particular, the present invention relates to a method for automatic configuration of a process control system and a process control system adapted to carry out the method.

### BACKGROUND OF THE INVENTION

With respect to measurement and control technology, and also with respect to process control systems, frequently sensors have to be connected to a control unit or to an analyzing system. Besides the physical connection of the components involved, usually also it is required to adapt the apparatus configuration of the processing system, i.e. the control unit, to the origin of the input data, i.e. the sensors. The arrangement of process control systems can basically be described as follows: on one hand, there is a field apparatus. This can for example be a sensor like a pressure measuring transducer, a level switch, a flow meter, and so on. Or this can also be an actuator like a valve, a slide valve, and so on.

Typically, the sensor provides measurement values via a bus system to the control unit, whereby respective measurement values have a different relevance according to the measuring method used. Thus, pressure sensors provide for example measurement values which are calibrated in pressure units as bar, Pascal or mmH₂O, whereas distance measuring sensors provide values, being calibrated in m, mm, or ft. Flow rates are usually measured by the systems in l/s, m³/h, or cftps, and so on.

On the other hand, there are control units, being termed as analyzing systems in the following. The control units typically are connected to a field apparatus via the above mentioned bus system. The task of analyzing systems is based on reading the input measurement values (of the field apparatus), to process them adequately, and then generate output control signals (switching signals, current signals, digital values, and so on) from the derived results.

Configuration of the analyzing system typically results via an input unit (keys and display) on the apparatus side, however, it can also result via a configuration interface by means of a PC. Where applicable, the processed data can also be transmitted via bus systems through gateways or further process control systems.

To comply with the tasks of the analyzing apparatus, different software blocks are provided. Each software block represents a black box. The black box comprises inputs for receiving input signals, and outputs for providing the processed signals. These software blocks respectively represent an object, classifying associated tasks such that the respective result values can be used as virtually calibrated for arbitrary subsequent blocks.

In this manner, a basis is established to divide a measuring task into individual single tasks. Usually, a subdivision is employed, using the following basic functions (basic components):
Input blocks (e.g., input components) performing an input function and
   comprising the set of information with respect to a connected field apparatus (address command, type of apparatus, input values).
   The input components receive their measurement values from the bus interface (possibly a communication component), and usually transmit them without any change to function components.
Function blocks (e.g., function components) performing a processing function, function components receive their input data, e.g. directly, from input components. During the processing of field apparatus input data, it has to be considered that for a further processing of e.g. pressure measurement values, other rules and functions are reasonable than they are for further processing of distance or flow values.
   Typical functions can be:
      “calibration to the container geometry”.
      “linearizing functions”,
      “integration time”,
      “consideration of the density”,
      “leak flow volume suppression”,
   or extended measuring tasks as
      “difference measurement”,
      “measurement in a pressurized container”,
      “continuous interface measurement, and
      “averaging”.
   Function components provide their resulting values for use in output components.
Output blocks (e.g., output components) performing an output function, output components receive their input data directly from function components. They serve for controlling and generating, of output signals, respectively (switching signals, current-voltage output or digital information).

To solve a complete measurement task in a control unit, in a most simple case a basic component of each type is required: input component, function component, and output component. The thus generated component structure for solution of a complete measurement task is termed as “measurement loop” in the following.

Within a control, a plurality of measurement loop can be processed. Therefore, if a control is connected to a plurality of field apparatuses via a bus system, then, by adequate configuring of the control unit, a corresponding set of measurement loops can be composed in the control unit from the pool of components. According to prior art, the configuration either results from an operating desk connected to the control or alternatively via a configuration computer via a bus connection. By this procedure, it is necessary for a user operating the system, to not only take account of the installation of the apparatus and its wiring, but rather to also carry out complicated configurations at the apparatus.

It would be desirable to reduce the operating complexity when starting these systems. Thus, it would be meaningful to improve the control units of such systems. The installation would be much easier, if the standard configuration profiles are set up automatically depending on the connected sensor.

Therefore, the control should be able to identify a sensor connected to its output and matching to a certain sensor profile, and then automatically set up the corresponding measurement loop profile. An immediately functioning measurement can be thus provided. Moreover, this process should be applicable via different bus systems (as HART, Profibus, Fieldbus Foundation, and so on), containing the necessary information for the sensors in form of parameters via the respective bus per definition.

It would be desirable that a plurality of sensor profiles can be identified automatically. A preferably exact profile should be determined for digitally communicating systems.

### SUMMARY OF THE INVENTION

It would be desirable to reduce the operating complexity when starting these systems. Thus, it may be meaningful to improve the control units of such systems. The installation may be much easier, if the standard configuration profiles are set up automatically depending on the connected sensor.

Therefore, the control may be able to identify a sensor connected to its output and matching to a certain sensor profile, and then automatically set up the corresponding measurement loop profile. An immediately functioning measurement may thus be provided. Moreover, this process may be applicable via different bus systems (as HART, Profibus, Fieldbus Foundation, and so on), containing the necessary information for the sensors in the form of parameters via the respective bus per definition.

Therefore, a plurality of sensor profiles may be identified automatically. An exact profile may be determined for digitally communicating systems.

Implementations of the invention can include one or more of the following features. According to an aspect of the invention, a method for automatic configuration of a process control system is provided, comprising a master and at least one slave, whereby the master controls the at least one slave, which is connected to and communicates with the master via a bus system, and processes data received from the at least one slave, whereby the master automatically identifies the at least one slave via the bus system, and subsequently automatically generates a slave configuration for setting up the slave according to its identification such that the slave is ready to be operated in the process control system.

In another aspect of the invention, the master is an analyzing apparatus, in particular a control unit, comprising allocation tables, from which the master selects the slave configuration for the slave identified.

According to a further aspect of the invention, the slave is a field apparatus, in particular a sensor or an actuator. The identification of the connected slave is carried out by means of the functionality of the master. Upon starting the process control system, communication towards the bus system is initiated by the master.

Yet another aspect of the invention is that for identifying the field apparatus, the master retrieves information concerning manufacturer, type, apparatus TAG by means of standardized commands. The master compares the identification data of the slave to slave profiles, contained in the allocation tables, to find the adequate apparatus profile to set up the slave for operation in the process control system.

Moreover, the master generates a measurement loop comprising an input component, an output component, and a function component for the slave configuration. The allocation table can also be supplemented by loading slave profiles.

In a further aspect of the invention, the automatically generated measurement loops are corrected interactively. During the correction of the measurement loops, the automatic generation of measurement loops is deactivated until new slaves are connected to the master or until the automatic measurement loop generation is reactivated.

According to yet another aspect, the automatic adaptation of already present measurement loops is carried out when an already connected slave is replaced by another type of slave.

According to an aspect of the present invention, a method for automatic configuration of a process control system is provided, comprising at least one field apparatus, which is connected via a bus system to an analyzing apparatus, whereby upon starting the analyzing apparatus, the latter verifies the presence of the field apparatus at the bus system at a certain bus address, and, upon response of the bus system, for identification of the field apparatus, requests information concerning manufacturer, type, and apparatus TAG of the field apparatus via the bus system, and subsequent to the identification, the analyzing system compares data retrieved during the identification process to field apparatus profiles stored in allocation tables of the analyzing apparatus, and, upon an coincidence, generates an apparatus configuration in form of a measurement loop, comprising an input component, a function component, and an output component, by means of which the field apparatus is ready for operation.

A further aspect of the present invention is a process control system, comprising a master and at least one slave, whereby the master is adapted to control the slave and to process data received from the slave, and the slave is adapted to be connected to and to communicate with the master via a bus system, whereby the master is adapted to automatically identify the slave via the bus system, and to subsequently generate a slave configuration for setting up the slave according to its identification such that the slave is ready to be operated in the process control system.

In the process control system, the master is an analyzing apparatus and the slave is a field apparatus according to an aspect of the invention. According to another aspect, the master is a control unit and the slave is a sensor or an actuator.

According to still another aspect, the master comprises allocation tables, which contain a number of predefined slave configurations suitable for a number of the field apparatuses. The allocation tables are supplementable via an input device.

Moreover, the bus system is a HART-bus system according to a further aspect of the invention. The bus system comprises commands for the master for requesting the presence of a slave at the bus system.

According to yet another aspect of the present invention, the allocation tables are supplementable by loading slave profiles.

It is another aspect of the invention that the master is adapted to generate a measurement loop for a specific identified slave. The measurement loop comprises at least one input component, at least one output component, and at least one function component.

Further, the allocation tables comprise fixed measurement loop profiles for each slave profile.

### BRIEF DESCRIPTION OF THE DRAWINGS

For further explanation and better understanding, several exemplary embodiments of the present invention will be described below in more detail with reference to the attached drawings:

FIG. 1 shows a schematic diagram of an arrangement of a process control system.

FIG. 2 shows a schematic diagram of another arrangement of a process control system.

FIG. 3 shows a schematic diagram, showing a measurement loopmethod.

FIG. 4a shows another schematic diagram, showing another arrangement of several measurement loopmethods.

FIG. 4b shows a schematic diagram, showing a further measurement lop method.

FIG. 5 shows a schematic diagram of a process control system according to an exemplary embodiment of the present invention.

FIG. 6 shows a further schematic diagram of the process control system according to the invention.

FIG. 7 shows a flow chart of according to an exemplary embodiment of a method of the present invention.

FIG. 8 shows a screenshot of a window for allocation of an input to a measurement loop.

FIG. 9 shows a screenshot of a window for the basic setting for a measurement loop.

FIG. 10 shows a screenshot of a window for allocation of percentage values to sensor input data.

FIG. 11 shows a screenshot of a window for settings for a relais.

### DESCRIPTION OF EXEMPLARY EMBODIMENTS OF THE INVENTION

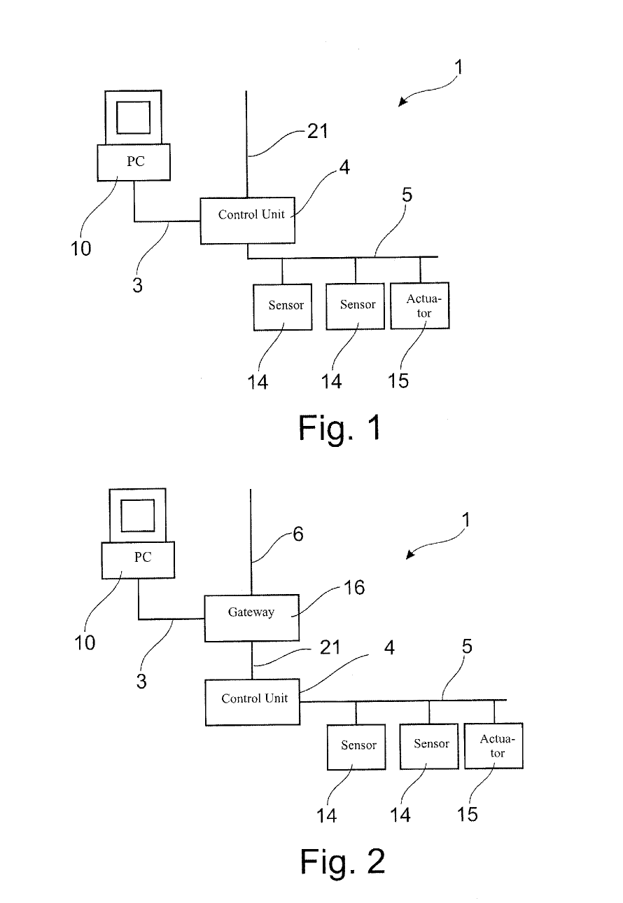

FIG. 1 is a schematic diagram of a process control system. A control unit 4 is connected via a bus system 5 to two sensors 14 and an actuator 15. Further, a PC 10 is connected to the control unit 4 via a configuration interface 3. The configuration of the process control system 1 results by means of an operating desk (e.g. a keyboard and a display). FIG. 2 is another schematic diagram of a further arrangement of a process control system. Here, a gateway 16 is connected between the control unit 4 and the PC 10. Thus, if need be, the processed data can be transferred to gateways 16 or to other process control systems.

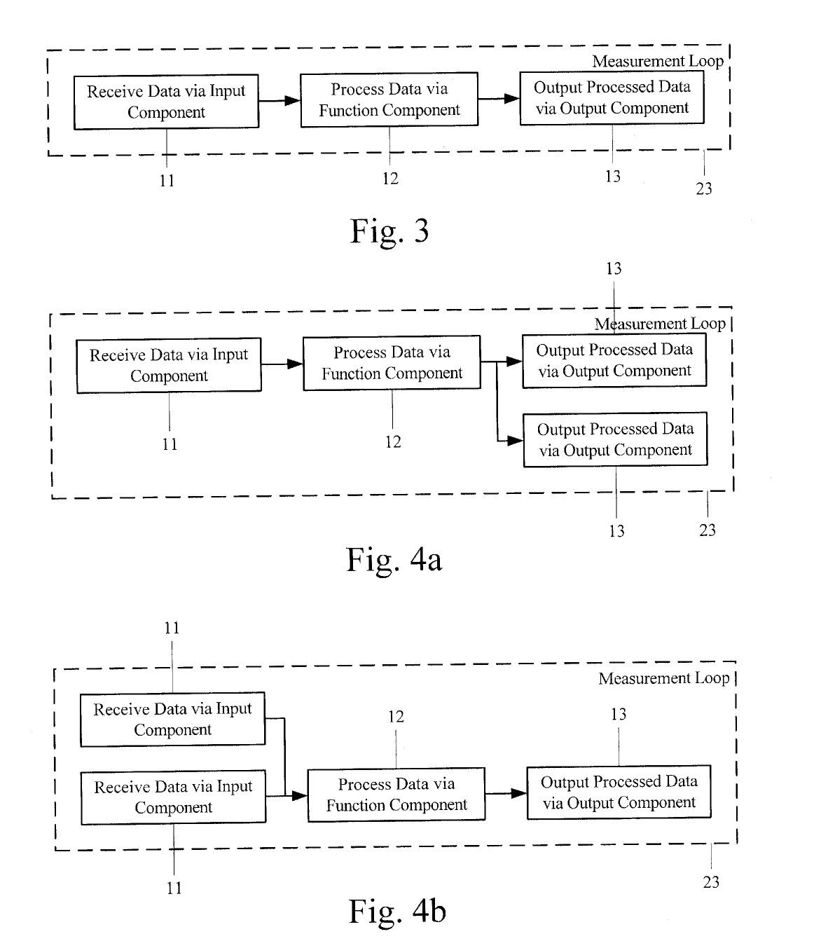

FIG. 3 shows a procedural method for a measurement loop 23, comprising a receiving step 11 via an input component or input block, a processing step 12 via a function component or function block, and an outputting step 13 via an output component or output block. As already mentioned, the function component receives data directly from the input component, and the output component 13 in turn receives data from the function component. This arrangement shows the most simple case to solve a complete measuring task in a control unit. FIG. 4a shows another procedural method for a control unit comprising another measurement loop with two outputting steps 13. FIG. 4b shows a further procedural method for a control unit comprising a further measurement loop with two receiving steps 11. In cases where the control unit 4 is connected to a plurality of field apparatuses 14 via the bus system 5, adequate configuring of the control unit 4 may provide a set of measurement loops which can be composed from a pool of components.

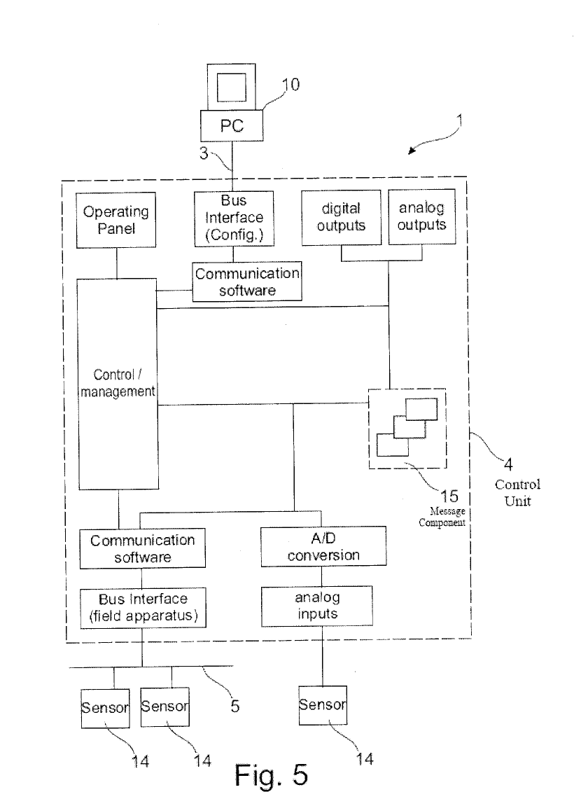

In FIG. 5, a system is shown, comprising a plurality of sensors 14, connected via a bus system 5 to the control unit 4. The control unit in turn is connected to a PC 10. Moreover, the control unit 4 comprises message components 15

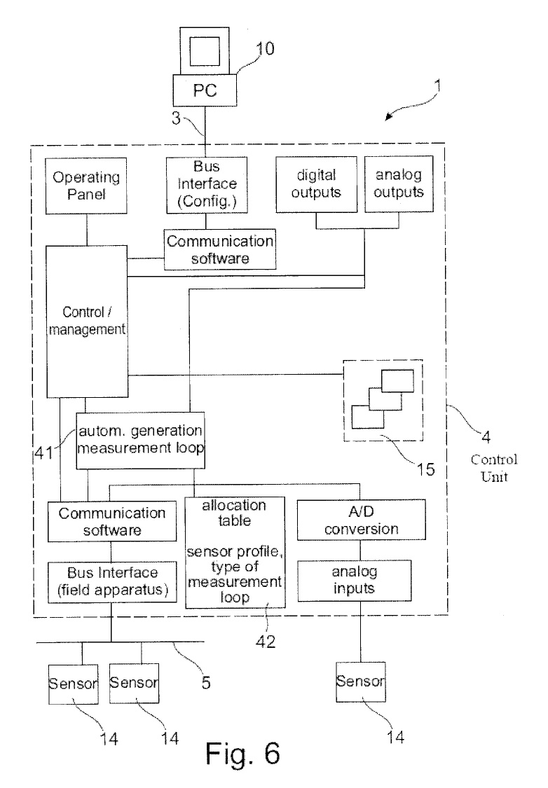

According to FIG. 6, a process control system according to the invention is shown. The process control system comprises the control unit 4 as master of the system and a couple of sensors as slaves of the system, connected thereto over a bus system 5.

Moreover, a PC 10 is connected to the control unit 4 which performs of the components, namely input components, function components, and output components for establishing a measurement loop 23. For automatic configuration, and thus automatic generation of a measurement loop 23, the control unit 4 comprises the allocation tables 42, comprising sensor profiles and type of measurement loop fitting thereto.

With respect to the sensors connected to the control unit 4, in case HART sensors are used having certain characteristics, these can be verified at HART input terminals; otherwise used PA sensors can e.g. be verified at Profibus inputs and so on.

In case of HART sensors, instead of smart sensors, pure 4-20 mA sensors can also be identified. This assumption is made, if the connection of a sensor is detected (by means of current consumption within certain limits), but, however, no reaction to the digital signal may result.

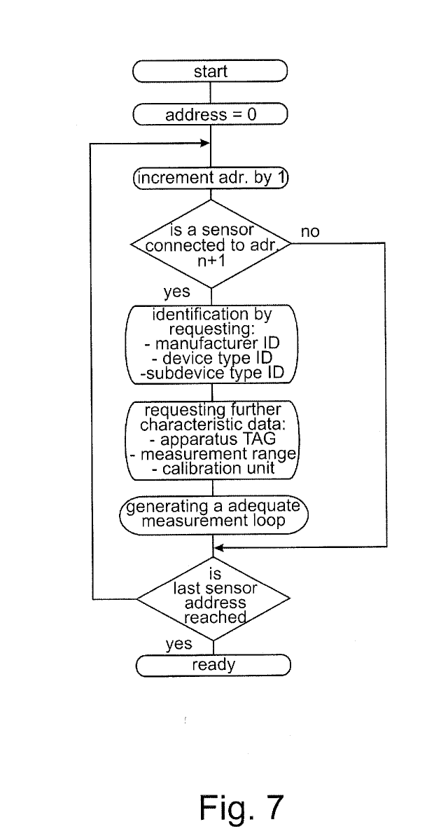

The identification of the connected sensor is carried out by means of the functionality, 41, the data flow of which is shown in FIG. 7 in principle.

Upon starting the process control system, the automatic measurement loop operation is started. That means that the control unit 4 automatically takes up communication towards the bus system 5.

The control unit requests—as master of the system—by means of “trial and error”—to a certain bus address, whether a slave 14, 15 is connected to the bus system 5 or not. For this procedure, the already mentioned bus systems provide special commands (e.g. according to HART, Universal Commands are used).

In case the analyzing apparatus receives a response after such a trial, then information with respect to manufacturer and type of apparatus is selectively inquired. This information can also be requested by means of standardized commands with respect to the already mentioned bus systems (excerpt of the definitions, see tables 1-3).

TABLE 1
Examples for manufacturer IDs

| Identifier | Value | Meaning |
|---|---|---|
| Manufacturer ID | 98 | Manufacturer: VEGA |
| Manufacturer ID | 42 | Manufacturer: Siemens |
| Manufacturer ID | 17 | Manufacturer: E+H |

TABLE 2
Device Type Codes HART-Sensors Series 60

| Type | Apparatus designation | Device type code (HART) |
|---|---|---|
| PULS | VEGAPULS | 232/0xE8 |
| FLEX | VEGAFLEX | 231/0xE7 |
| SON | VEGASON | 230/0xE6 |
| SWING | VEGASWING | 229/0xE5 |
| VIB | VEGAVIB | 228/0xE4 |
| CAP | VEGACAP | 227/0xE3 |
| BAR | VEGABAR | 226/0xE2 |
| DIF | VEGADIF | 225/0xE1 |

TABLE 3
Device Type Codes Profibus-Sensors Series 60

Apparatus ID

| | | VEGA | Profile 3 |
|---|---|---|---|
| SON | VEGASON | 0x0770 | 0x9701 |
| FLEX | VEGAFLEX | 0x0771 | 0x9700 |
| PULS | VEGAPULS | 0x0772 | 0x9700 |
| CAP | VEGACAP | 0x076E | 0x9700 |
| BAR | VEGABAR | 0x076F | 0x9701 |

Further, the slaves provide information over fixedly defined commands for the stored apparatus TAG. According to information received concerning the type of apparatus, an advanced analysis for the sensor connected thereto may be carried out. Thus, for example it may be determined, in which measurement range and according to which physical measurement category the sensor is operated.

If the control unit, i.e. the analyzing apparatus, has identified a type of apparatus (sensor, actuator), then it carries out a comparison of the input data with sensor profiles fixedly stored in the control unit 4 in allocation tables 42. When a matching sensor profile is found, then the control automatically generates adequate measurement loop configurations. It also generates a complete measurement loop 23 according to FIG. 5, consisting of an appropriate input component, a function component, and an output component.

TABLE 4
Excerpt of the allocation instruction for input components

Input component initialization

| Sensor profile | Input value | HART address |
|---|---|---|
| Son | Distance | Appropriate for slave |
| Puls | Distance | Appropriate for slave |
| Flex | Distance | Appropriate for slave |
| Bar | Pressure | Appropriate for slave |
| HART Generic | PV | Appropriate for slave |
| 4-20 mA | Current | — |

TABLE 5
Excerpt of the allocation instruction for function components

| | Function component initialization | | |
|---|---|---|---|
| Sensor profile | measurement loop tag | Application | Calibration unit |
| Son | Device TAG | Level | m |
| Puls | Device TAG | Level | m |
| Flex | Device TAG | Level | m |
| Bar | Device TAG | Level | bar |

An example by means of a bus system “HART” is:
Slave to address=2
Manufacturer ID=98 VEGA Grieshaber KG
Device Type Code=232 VEGAPULS

The control unit 4 receives a response under HART address 2 from a slave 14 (see FIG. 7). The further communication procedures provide data from the example shown above.

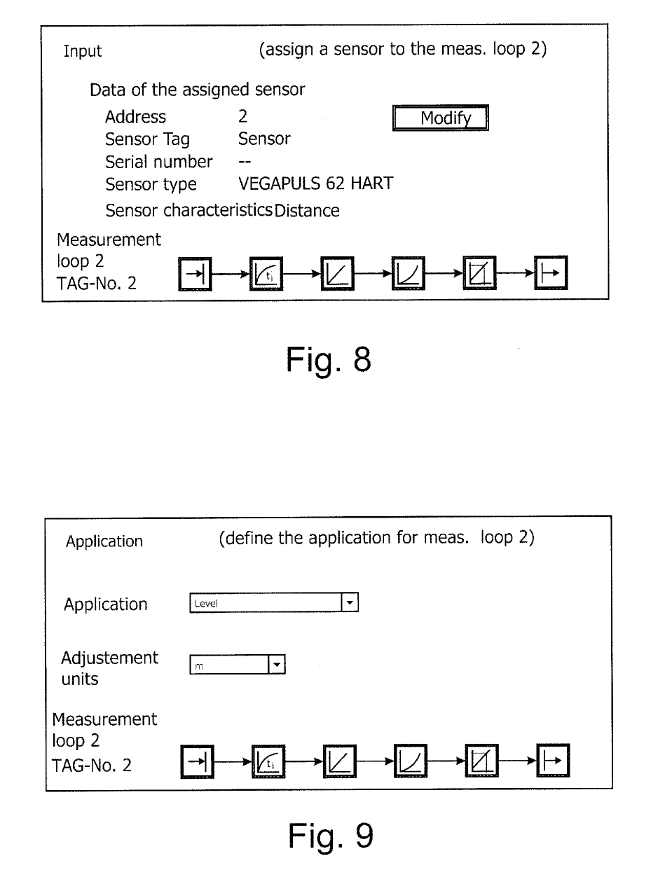

In FIG. 8 it can be seen that the analyzing apparatus generates an input component for distance measurement and generates the measuring principle RADAR for HART address 2.

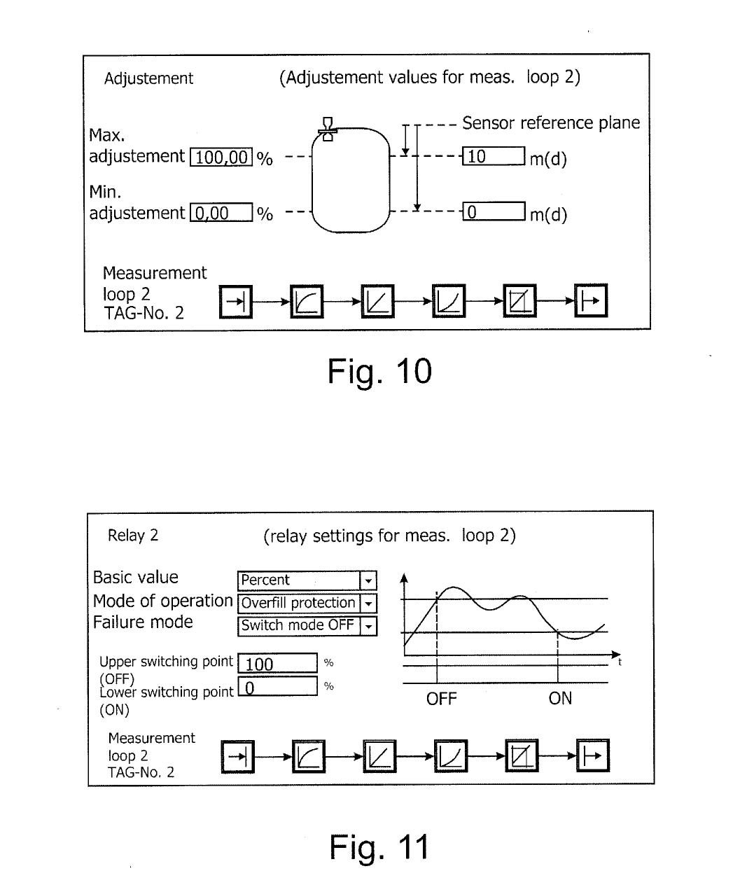

Also adequate for the identified sensor profile, the control unit generates a function component for level measurement comprising the calibration unit “meter” (see FIG. 9). According to a known measurement range, the latter is automatically entered into the function component as calibration range (see FIG. 10).

Because the output components are independent of the input component and the selected measuring value processing block (function component), the control unit selects for this purpose the output component type most frequently required, namely a switching output, configured for the switching function “overfill protection” (FIG. 11).

When starting the process control system, the user receives—without any further assistance—an adequate measurement loop for the sensor connected, comprising an input component, a function component, and an output component, rendering the system ready to be operated.

Besides the fixedly predetermined sensor profiles/measurement loop type, the allocation table 42 can also be adapted to be supplementable by reloadable profiles. According to this, the allocation table contains two types of data set entries:
a) Fixed measurement loop profiles for each sensor profile are stored in the control unit, which are activated accordingly.
b) The user himself has stored a set of adapted profiles, which are activated accordingly.

Moreover, automatically generated measurement loop profiles can be interactively corrected by the user. In case interactive correction has been carried out, then the automatic generation of measurement units 23 is deactivated until either new slaves (having different identification characteristics) are connected to the control unit/analyzing apparatus, or the control unit is reactivated by means of a function defined for this purpose (for example a reset key or a function initiated by software) for carrying out the automatic measurement loop generation.

In case, the already existing measurement loop sensors are replaced by other sensor types, also the automatic adaptation of already present measurement loop can be carried out. Should the actual measuring task be maintained in this case, it is adequate to request for the desired procedure via a dialogue:

a) generating a completely new measurement loop (according to the above mentioned method)
b) adapting the input component to the new slave.

The invention can be applied to simple one-channel analyzing systems as well as to complex systems.

1-21. (canceled)

22. A control unit, comprising:
a pool of components,
wherein the control unit identifies an apparatus profile of an apparatus connected to the control unit,
wherein the control unit generate an adequate measurement loop a as function of the apparatus profile, and
wherein, based on the adequate measurement loop, (a) the pool of components is configured and (b) a measuring task in the control unit is solved.

23. A process control system, comprising
a master, and
at least one slave,
wherein the master is adapted to control the slave and to process data received from the slave,
wherein the slave is adapted to be connected to and to communicate with the master via a bus system,
wherein the master is adapted to automatically identify the slave via the bus system, and to subsequently, generate an apparatus configuration for setting up the slave according to its identification such that the slave is ready to be operated in the process control system,
wherein the master is adapted to generate a measurement loop for a specific identified slave, and
wherein the measurement loop comprises at least one input component, at least one output component, and at least one function component.

24. The process control system according to claim 23, wherein the master is an analyzing apparatus and the slave is a field apparatus.

25. The process control system according to claim 23, wherein the master is a control unit and the slave is one of a sensor and an actuator.

26. The process control system according to claim 23, wherein the master comprises allocation tables, which contain a number of predefined apparatus configurations suitable for a number of the field apparatuses.

27. The process control system according to claim 26, wherein the allocation tables are supplementable via an input device.

28. The process control system according to claim 23, wherein the bus system is a HART-bus system.

29. The process control system according to claim 23, wherein the bus system comprises commands for the master for requesting the presence of a slave at the bus system.

30. The process control system according to claim 26, wherein the allocation tables are supplementable by reloadable adapted apparatus profiles.

31. The process control system according to claim 26, wherein the allocation tables comprise fixed measurement loop profiles for each apparatus profile.

32. A method for configuring a control unit including a pool of components, comprising:
identifying an apparatus profile of an apparatus connected to the control unit;
generating an adequate measurement loop based on the apparatus profile; and
based on the adequate measurement loop, configuring the pool of components and solving a measuring task in the control unit.

33. A method for automatic configuration of a process control system comprising a master and at least one slave, comprising:
controlling the at least one slave by means of the master, wherein the at least one slave is connected to and communicates with the master via a bus system, and processing data received from the at least one slave by means of the master;
automatically identifying the at least one slave by means of the master via the bus system, and subsequently automatically generating an apparatus configuration for setting up the slave according to its identification such that the slave is ready to be operated in the process control system; and
generating, by means of the master, a measurement loop comprising an input component, an output component, and a function component for the apparatus configuration.

34. The method according to claim 33, wherein the master is an analyzing apparatus, in particular a control unit, comprising allocation tables, from which it selects the adequate apparatus configuration for the slave identified.

35. The method according to claim 33, wherein the slave is a field apparatus, and in particular one of a sensor and an actuator.

36. The method according to claim 33, wherein the identification of the connected slave is carried out by means of the functionality of the master.

37. The method according to claim 33, wherein upon starting the process control system, communication towards the bus system is initiated by the master.

38. The method according to claim 33, wherein for identifying the field apparatus, the master retrieves information concerning manufacturer, type, apparatus TAG by means of standardized commands.

39. The method according to claim 33, wherein the master compares the identification data of the slave to apparatus profiles, contained in the allocation tables, to find the adequate apparatus profile to set up the slave for operation in the process control system.

40. The method according to claim 33, wherein the allocation table is supplemented by reloadable adapted apparatus profiles.

41. The method according to claim 33, wherein automatically generated measurement loop are corrected interactively.

42. The method according to claim 33, wherein during the correction of the measurement loop, the automatic generation of measurement loop is deactivated until new slaves are connected to the master or until the automatic measurement loop generation is reactivated.

43. The method according to claim 33, wherein the automatic adaptation of already present measurement loop is carried out when an already connected slave is replaced by another type of slave.

44. A method for automatic configuration of a process control system, comprising at least one field apparatus, which is connected via a bus system to an analyzing apparatus, comprising:
verifying, upon starting the analyzing apparatus, the presence of the field apparatus at the bus system at a certain bus address by means of the analyzing apparatus;
requesting, upon response of the bus system, for identification of the field apparatus, information concerning manufacturer, type, and apparatus TAG of the field apparatus via the bus system by means of the analyzing apparatus;
comparing, subsequent to the identification, data retrieved during the identification process to field apparatus profiles stored in allocation tables of the analyzing apparatus by means of the analyzing system; and
generating, by means of the analyzing system and upon an coincidence, an apparatus configuration in form of a measurement loop, comprising an input component, a function component, and an output component, by means of which the field apparatus is ready for operation.
